(19) United States
(12) Patent Application Publication
(10) Pub. No.: US 2024/0078699 A1
(43) Pub. Date: Mar. 7, 2024

(54) IMAGE PROCESSING APPARATUS, IMAGE PROCESSING METHOD, AND NON-TRANSITORY STORAGE MEDIUM

(71) Applicant: NEC Corporation, Minato-ku, Tokyo (JP)

(72) Inventor: Toshihiko Fujii, Tokyo (JP)

(73) Assignee: NEC Corporation, Minato-ku, Tokyo (JP)

(21) Appl. No.: 18/272,522

(22) PCT Filed: Dec. 15, 2021
(86) PCT No.: PCT/JP2021/046212

§ 371 Date: Jul. 14, 2023

(30) Foreign Application Priority Data
Jan. 19, 2021 (JP) 2021-006332

(51) Int. Cl. G06T 7/73; G06V 10/25; G06V 10/44

(52) U.S. Cl. CPC G06T 7/73; G06V 10/25; G06V 10/44; G06T 2207/20044; G06V 2201/07

(57) ABSTRACT

An image processing apparatus (10) according to the present invention includes: a user area determination unit (11) that determines, from an image to be processed, a user area being an area where a user of an operation terminal is present; and a user switching detection unit (12) that detects, based on an image of the user area, that the user of the operation terminal is switched.

### TECHNICAL FIELD

The present invention relates to an image processing apparatus, an image processing method, and a program.

### BACKGROUND ART

A technique for reducing billing fraud damage has been desired. A related technique is disclosed in Patent Documents 1 and 2. Patent Documents 1 and 2 disclose a technique for analyzing an image generated by a surveillance camera installed in an operation terminal such as an automated teller machine (ATM) and thereby determining a person, and deciding whether the determined person is calling on a mobile phone. Further, Patent Document 1 discloses a technique for deciding a person who is using an operation terminal for a long time as being encountering billing fraud or having a possibility of this matter.

Related Document

Patent Document
Patent Document 1: Japanese Patent Application Publication No. 2010-238204
Patent Document 2: Japanese Patent Application Publication No. 2010-218392

### DISCLOSURE OF THE INVENTION

Technical Problem

As a behavior tendency during operation of an operation terminal by a victim of fraud such as billing fraud, a matter that “an operation is being performed while calling on a mobile phone”, a matter that “usage is made for a long time”, and the like are known. As disclosed in Patent Documents 1 and 2, a person who is taking these pieces of behavior is detected by an image analysis, and thereby fraud damage can be reduced. However, the present inventors have newly found the following problem in the technique.

Among surveillance cameras installed in order to capture an image of a user of an operation terminal, there may be a surveillance camera exhibiting low performance (e.g., a low frame rate, low resolution, or the like), and therefore being not capable of clearly recording details of a face and behavior of the user of the operation terminal. Further, there may be a surveillance camera being installed in a location and a direction where an image of a user of an operation terminal is captured from an upper side or an obliquely-upper side, and therefore being not capable of recording, based on a face recognition technique, details of a face of the user of the operation terminal to an extent capable of being accurately recognized. The installation number of operation terminals is enormous, and therefore there is a heavy burden on work for replacing every surveillance camera with a high-performance surveillance camera and for modifying a location and a direction of installation.

An issue according to the present invention is to provide a technique for detecting, with high accuracy, based on an image generated by a surveillance camera having limitation to performance and an installation location, a fraud victim or a person having a possibility of the fraud victim.

### Solution to Problem

According to the present invention,

provided is an image processing apparatus including:

a user area determination unit that determines, from an image to be processed, a user area being an area where a user of an operation terminal is present; and

a user switching detection unit that detects, based on an image of the user area, that the user of the operation terminal is switched.

Further, according to the present invention,

provided is an image processing method including,

by a computer:
determining, from an image to be processed, a user area being an area where a user of an operation terminal is present; and
detecting, based on an image of the user area, that the user of the operation terminal is switched.

Further, according to the present invention,

provided is a program causing a computer to function as:
a user area determination unit that determines, from an image to be processed, a user area being an area where a user of an operation terminal is present; and
a user switching detection unit that detects, based on an image of the user area, that the user of the operation terminal is switched.

### Advantageous Effects of Invention

According to the present invention, a technique for detecting, with high accuracy, based on an image generated by a surveillance camera having limitation to performance and an installation location, a fraud victim or a person having a possibility of the fraud victim is achieved.

### BRIEF DESCRIPTION OF THE DRAWINGS

FIG. 1 is a diagram illustrating an image generated by a surveillance camera according to the present example embodiment.

FIG. 2 is a diagram illustrating an image generated by the surveillance camera according to the present example embodiment.

FIG. 3 is a diagram illustrating an image generated by the surveillance camera according to the present example embodiment.

FIG. 4 is one example of a function block diagram of an image processing apparatus according to the present example embodiment.

FIG. 5 is a diagram illustrating one example of a result of detecting a person area.

FIG. 6 is a diagram illustrating processing of determining a user area according to the present example embodiment.

FIG. 7 is a diagram illustrating processing of detecting switching of a user according to the present example embodiment.

FIG. 8 is a flowchart illustrating one example of a flow of processing of the image processing apparatus according to the present example embodiment.

FIG. 9 is a diagram illustrating one example of a hardware configuration of the image processing apparatus according to the present example embodiment.

FIG. 10 is one example of a function block diagram of the image processing apparatus according to the present example embodiment.

FIG. 11 is a diagram illustrating phone call pose detection processing according to the present example embodiment.

FIG. 12 is a diagram illustrating processing of computing a degree of certainty in which a user takes a predetermined pose according to the present example embodiment.

FIG. 13 is a flowchart illustrating one example of a flow of processing of the image processing apparatus according to the present example embodiment.

FIG. 14 is a flowchart illustrating one example of a flow of processing of the image processing apparatus according to the present example embodiment.

FIG. 15 is one example of a function block diagram of the image processing apparatus according to the present example embodiment.

### DESCRIPTION OF EMBODIMENTS

Hereinafter, example embodiments according to the present invention are described by using the accompanying drawings. Note that, in all drawings, a similar component is assigned with a similar reference sign, and thereby description is omitted, as appropriate.

### First Example Embodiment

### “Regarding Image Generated by Surveillance Camera”

An image processing apparatus according to the present example embodiment analyzes an image generated by a surveillance camera installed in order to capture an image of a user of an operation terminal such as an ATM, and detects, with high accuracy, a fraud victim or a person having a possibility of the fraud victim. The fraud is, but not limited to, for example, billing fraud.

Herein, an image generated by a surveillance camera is described. The surveillance camera has limitation to performance and an installation location. Therefore, the surveillance camera cannot clearly record details of a face and behavior of a user of an operation terminal.

For example, a camera exhibiting low performance (e.g., a low frame rate, low resolution, or the like) is used as a surveillance camera. In this case, the surveillance camera cannot clearly record details of a face and behavior of a user of an operation terminal.

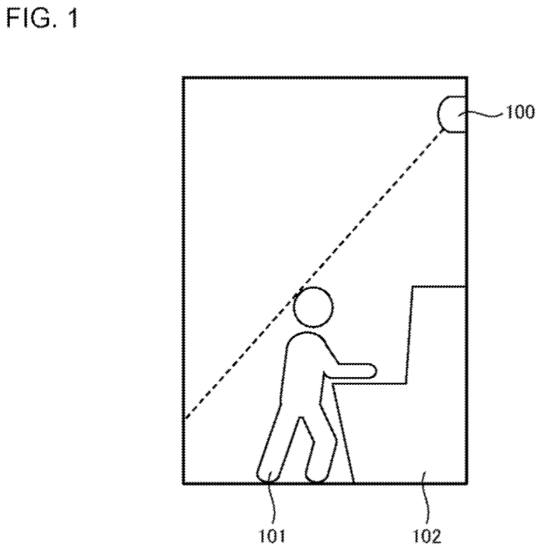

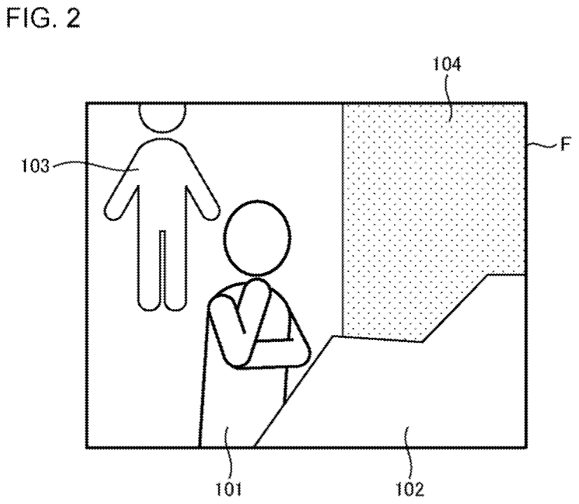

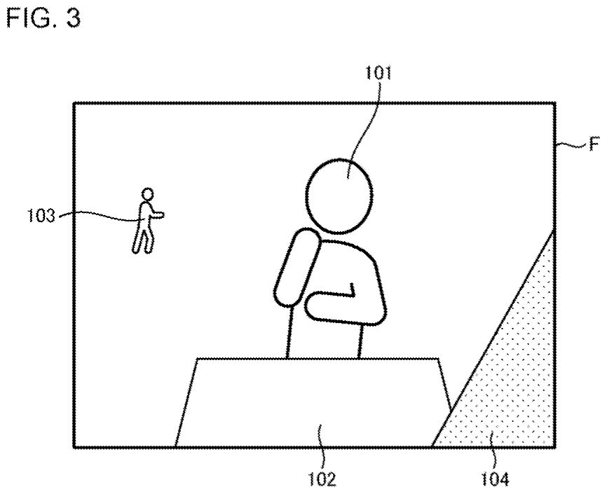

Further, for example, as illustrated in FIG. 1, a surveillance camera 100 is installed in a location and a direction where an image of a user 101 of an operation terminal 102 is captured from an upper side or an obliquely-upper side. In other words, the surveillance camera 100 may be installed in a location and a direction where an image of a face of the user 101 of the operation terminal 102 cannot be captured from a front. In this case, the surveillance camera 100 cannot record details of the face of the user 101 of the operation terminal 102 to an extent capable of being accurately recognized based on a face recognition technique. Further, in a generated image, a person other than the user 101 or an object may be included. For example, as illustrated in FIGS. 2 and 3, in an image F generated by the surveillance camera 100, in addition to the user 101 present in front of the operation terminal 102, the operation terminal 102, another person 103 such as a person being waiting for his/her order or a passerby, another object 104 such as a wall or a partition, or the like may be included.

### “Outline of Image Processing Apparatus”

Next, an outline of the image processing apparatus according to the present example embodiment is described. The image processing apparatus according to the present example embodiment executes, based on an image generated by a surveillance camera, processing of detecting, with high accuracy, a fraud victim or a person having a possibility of the fraud victim.

Specifically, the image processing apparatus according to the present example embodiment executes, based on an image generated by a surveillance camera, “processing of determining, from an image to be processed, a user area being an area where a user of an operation terminal is present” and “processing of detecting, based on an image of the user area, that a user of the operation terminal is switched”.

One main feature of the image processing apparatus according to the present example embodiment is that “processing of detecting that a user of an operation terminal is switched” is executed. Based on the detection result, a usage time of the operation terminal of each user can be determined.

When a surveillance camera exhibits high performance (e.g., a high frame rate, high resolution, or the like) or is installed in an appropriate location and direction, a plurality of users detected in an image can be discriminated, with high accuracy, from each other, by using a well-known tracking technique or a face recognition technique. Therefore, it is unnecessary to purposely execute processing of detecting that a user of an operation terminal is switched. Actually, in the technique described in Patent Documents 1 and 2 in which it is conceivable that it is assumed that a surveillance camera exhibits high performance and is installed in an appropriate location and direction, “processing of detecting that a user of an operation terminal is switched” is not executed.

However, as seen according to the present example embodiment, when a surveillance camera exhibits low performance (e.g., a low frame rate, low resolution, or the like) or an installation location is not appropriate, it is difficult to discriminate, with high accuracy, a plurality of users detected in an image from each other, by using a well-known tracking technique or a face recognition technique. As a result, there is a risk that users different from each other is determined as the same person, or that the same person captured over a plurality of images is determined as users different from each other. As a result, accuracy of a computation result of a usage time of an operation terminal of each user is worsened.

Therefore, the image processing apparatus according to the present example embodiment executes “processing of detecting that a user of an operation terminal is switched” which has not been executed in a conventional technique, and computes, based on the detection result, a usage time of the operation terminal of each user. As a result, even when a surveillance camera has limitation to performance and an installation location, a usage time of an operation terminal of each user can be accurately computed.

Another main feature of the image processing apparatus according to the present example embodiment is that any of the pieces of processing executed by the image processing apparatus includes a characteristic content suitable for processing for an image generated by a surveillance camera having limitation to performance and an installation location. Therefore, even when a surveillance camera has limitation to performance and an installation location, accuracy of the processing is improved. As a result, a usage time of an operation terminal of each user can be accurately computed.

### “Function Configuration of Image Processing Apparatus”

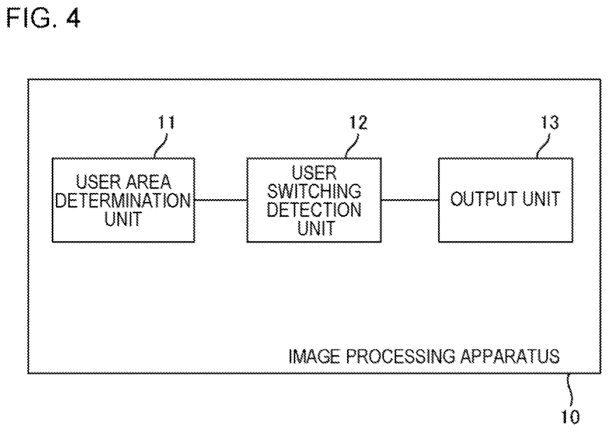

Next, a function configuration of the image processing apparatus is described in detail. FIG. 4 illustrates one example of a function block diagram of an image processing apparatus 10 according to the present example embodiment. As illustrated, the image processing apparatus 10 includes a user area determination unit 11, a user switching detection unit 12, and an output unit 13.

The user area determination unit 11 determines, from an image to be processed, a user area being an area where a user of an operation terminal is present.

The “image to be processed” is an image generated by the above-described surveillance camera. The surveillance camera is installed in a location and a direction where an image of a user of an operation terminal is captured, and generates a moving image. A plurality of images included in the moving image are images to be processed in time-series order (image-capture order).

Next, processing of determining a user area from an image to be processed is described. The user area determination unit 11 detects a person area from an image to be processed, and determines, as a user area, one of one or a plurality of detected person areas. Hereinafter, description is made in detail.

Processing of Detecting Person Area from Image to be Processed

Processing of detecting a person area from an image to be processed can be achieved by using every well-known person detection technique. The processing may be achieved, for example, by using a model for detecting a person generated based on machine learning, or may be achieved by using another means. In a well-known person detection technique, for example, a rectangular area including a person is detected as a person area.

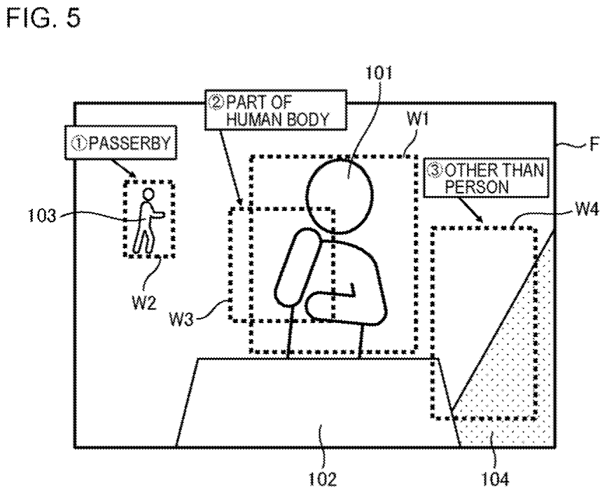

Note that, as described above, a surveillance camera has limitation to performance and an installation location. Therefore, accuracy of processing of detecting the person area is not sufficient either. As a result, a part of a person or the another object 104 other than the person may be erroneously recognized as a person. Further, as described above, when a surveillance camera captures an image from an upper side or an obliquely-upper side, an image also including the another person 103 is generated. As a result, processing of detecting the person area may also detect the another person 103. As a result, processing of detecting a person area from an image to be processed may detect, as illustrated in FIG. 5, in addition to a person area W1 including the user 101, a person area W2 including the another person 103, a person area W3 including only a part of a person, a person area W4 including the another object 104, and the like. Therefore, the user area determination unit 11 executes “processing of determining, as a user area, one of one or a plurality of detected person areas”, and determines an appropriate user area (an area including the user 101) from the detected person area.

### Processing of Determining, as User Area, One of One or Plurality of Detected Person Areas

The user area determination unit 11 uses, in the processing, a first detection result in which a person area is detected from an image to be processed and a second detection result in which a keypoint of a skeleton of a person is detected from the image to be processed.

The first detection result includes a size of each detected person area and a degree of certainty. The size of a person area is a size of an area occupied by the person area, and can be represented, for example, based on the number of pixels and the like. The degree of certainty is a value (a scale indicating to what extent a result is certain) indicating a degree of certainty in which the person area is an area including a person. In a well-known person detection technique, a technique for computing such a degree of certainty is widely known.

The second detection result includes coordinates (information indicating a location in an image) of each of a plurality of keypoints of a skeleton of a person detected from an image to be processed. Detection of a keypoint of a skeleton of a person is achieved by using a well-known technique such as OpenPose.

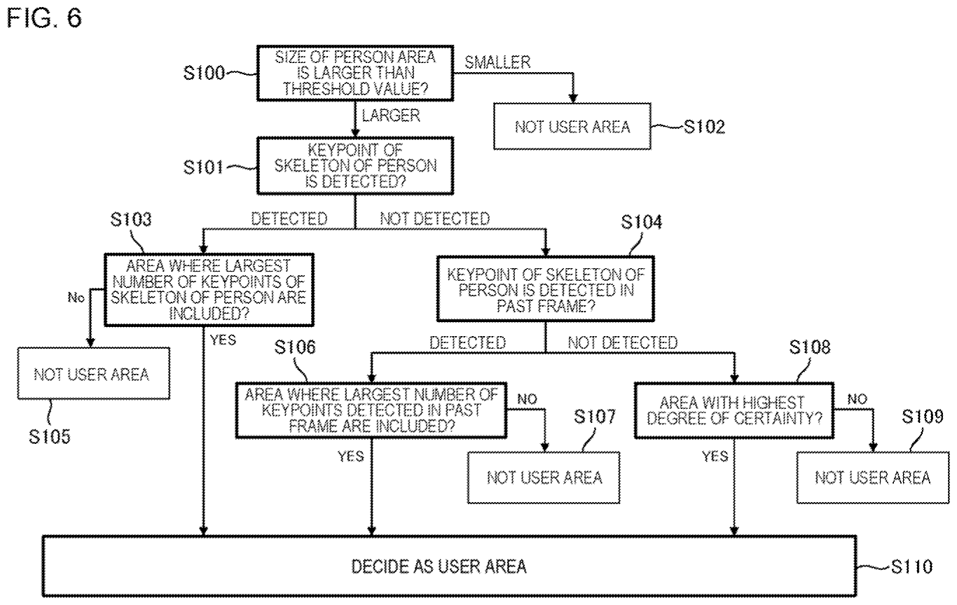

The user area determination unit 11 determines, by using the first detection result and the second detection result, from one or a plurality of detected person areas, one most appropriate person area as a person area including a user of an operation terminal. Specifically, the user area determination unit 11 applies a determination method illustrated in FIG. 6 to each of one or a plurality of detected person areas as a processing target, and decides whether each person area is a user area.

In S100, the user area determination unit 11 determines whether a size of a person area to be processed is larger than a previously-set threshold value. When the size of the person area to be processed is smaller than the threshold value (“smaller” in S100), the user area determination unit 11 decides that the person area to be processed is not a user area (S102).

When the size of the person area to be processed is larger than the threshold value (“larger” in S100), the user area determination unit 11 determines whether even one keypoint of a skeleton of a person is detected from an image to be processed including the person area to be processed (S101). When the detection is performed (“detected” in S101), the user area determination unit 11 determines, based on the number of keypoints of the skeleton of the person included in each of one or a plurality of detected person areas, whether the number of keypoints in the person area to be processed is largest (S103).

When the number is largest (“YES” in S103), the user area determination unit 11 decides that the person area to be processed is a user area (S110). On the other hand, when the number is not largest (“NO” in S103), the user area determination unit 11 decides that the person area to be processed is not a user area (S105).

Note that, when a keypoint of a skeleton of a person is not detected from an image to be processed including a person area to be processed (“not detected” in S101), the user area determination unit 11 determines whether even one keypoint of the skeleton of the person is detected from an image to be referred to (S104).

The “image to be referred to” is an image generated before an image to be processed including a person area to be processed, and is an image including a user of an operation terminal included in the image to be processed. The image to be referred to changes dynamically. One example of processing of determining an image to be referred to is described below.

When a keypoint of the skeleton of the person is detected from the image to be referred to (“detected” in S104), the user area determination unit 11 determines, based on an area occupied in an image of each of one or a plurality of detected person areas and coordinates in an image of each of keypoints of the skeleton of the person detected from the image to be referred to, an inclusion relation between a person area detected from the image to be processed and a keypoint of the skeleton of the person detected from the image to be referred to. Then, the user area determination unit 11 determines, from one or a plurality of detected person areas, whether a person area in which the number of included keypoints of the skeleton of the person is largest is a person area to be processed (S106).

When it is largest (“YES” in S106), the user area determination unit 11 decides that the person area to be processed is a user area (S110). On the other hand, when it is not largest (“NO” in S106), the user area determination unit 11 decides that the person area to be processed is not a user area (S107).

Note that, when a keypoint of the skeleton of the person is not detected from the image to be referred to (“not detected” in S104), the user area determination unit 11 determines, from one or a plurality of detected person areas, whether a person area in which a degree of certainty (a degree of certainty indicated by a first detection result) is largest is a person area to be processed (S108).

When it is largest (“YES” in S108), the user area determination unit 11 decides that the person area to be processed is a user area (S110). On the other hand, when it is not largest (“NO” in S108), the user area determination unit 11 decides that the person area to be processed is not a user area (S109).

In this manner, the user area determination unit 11 can determine, based on a first detection result in which a person area is detected from an image to be processed and a second detection result in which a keypoint of a skeleton of a person is detected from the image to be processed, a user area from the image to be processed. Further, when a keypoint of the skeleton of the person is not detected from the image to be processed, the user area determination unit 11 can determine, based on a keypoint of the skeleton of the person detected from an image to be referred to generated before the image to be processed, a user area from the image to be processed.

Referring back to FIG. 4, the user switching detection unit 12 detects, based on an image of a user area determined by the user area determination unit 11, that a user of an operation terminal is switched. The user switching detection unit 12 detects, based on a comparison result between feature data extracted from an image of a user area in an image to be processed and feature data extracted from an image of a user area in an image to be compared, that a user of an operation terminal is switched (a user in the image to be processed and a user in the image to be compared are different from each other).

The “feature data extracted from an image of a user area” are data indicating a feature of an appearance of a user indicated by an image. As one example, for example, a feature of clothes, a feature of a hair style, a feature of a face, and presence/absence and a feature of glasses, a hat, or the like, and the like are exemplified without limitation.

The “image to be compared” is an image generated before an image to be processed. The image to be compared changes dynamically. One example of processing of determining an image to be compared is described below.

Note that, the above-described “image to be referred to” and the “image to be compared” are common to a point that any of the image is an “image generated before an image to be processed”. However, there is a difference in that while the “image to be referred to” is an image used for the above-described “processing of deciding a user area”, the “image to be compared” is an image used for the above-described “processing of detecting switching of a user of an operation terminal”.

Note that, as described above, a surveillance camera has limitation to performance and an installation location. Therefore, accuracy of the processing of deciding whether to be the same person, based on comparison of pieces of feature data is insufficient. Therefore, the user switching detection unit 12 decides, when decision as not being the same person is made in continuous M (M is an integer equal to or more than 2) or more images to be processed, that a user of an operation terminal is switched. Then, the user switching detection unit 12 decides, as a timing of switching of the user of the operation terminal, a timing at which an image to be processed in which a time-series order in the continuous M images to be processed earliest is generated.

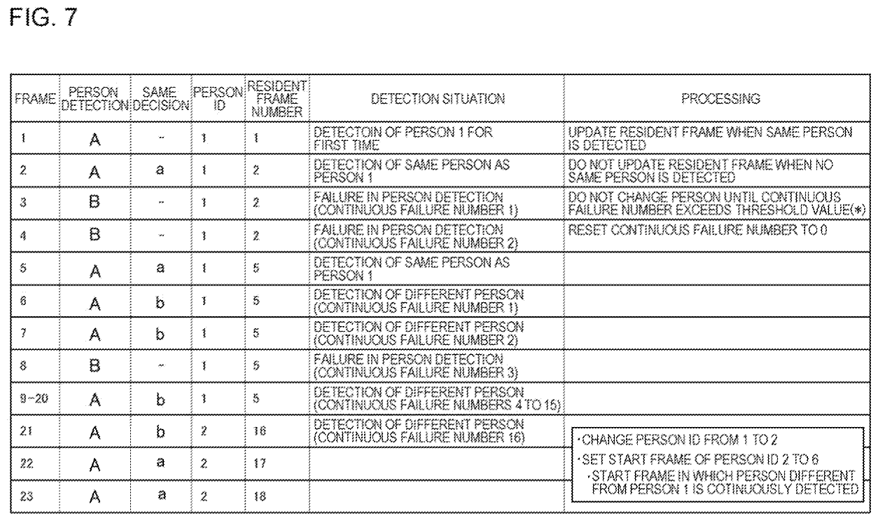

Hereinafter, the processing is described by using a specific example illustrated in FIG. 7. Further, the image to be referred to and the image to be compared described above are also described. Note that, M is assumed to be “16”.

First, an image of a frame number 1 is designated as an image to be processed, and processing by the user area determination unit 11 is executed. Herein, it is assumed that a user area is determined (person detection “o”). The image processing apparatus 10 sets a person identifier (ID) “1” for a person (a user of an operation terminal) included in the user area, and sets “1” as a resident frame number. Further, the image of the frame number 1 is set as an image to be referred to and an image to be compared. Note that, a frame before the frame number 1 is not present, and therefore processing by the user switching detection unit 12 is not executed.

Next, an image of a frame number 2 is designated as an image to be processed, and processing by the user area determination unit 11 is executed. Herein, it is assumed that a user area is determined (person detection “o”). Then, the user switching detection unit 12 compares feature data extracted from an image of the user area in the image to be processed with feature data extracted from an image of a user area in an image to be compared. The user switching detection unit 12 decides, when a degree of similarity is equal to or more than a reference value, that persons included in the two images are the same person, and decides, when the degree of similarity is less than the reference value, that the persons are not the same person. Herein, it is assumed that decision as being the same person is made (same decision “o”). The image processing apparatus 10 causes the person ID to remain as “1”, and updates the resident frame number to “2”. Then, the image processing apparatus 10 updates the image to be referred to and the image to be compared to the image of the frame number 2.

Next, an image of a frame number 3 is designated as an image to be processed, and processing by the user area determination unit 11 is executed. Herein, it is assumed that a user area is not determined (person detection “x”). A situation where a user area is not determined is, for example, a case where a user area having a size equal to or more than a threshold value is not detected (“smaller” in S100 in FIG. 6), or the like. In this case, processing by the user switching detection unit 12 is not executed. The image processing apparatus 10 causes the person ID to remain as “1”, causes the resident frame number to remain as “2”, and sets a continuous failure number “1”. Then, the image processing apparatus 10 causes the image to be referred to and the image to be compared to remain as the image of the frame number 2.

Next, an image of a frame number 4 is designated as an image to be processed, and processing by the user area determination unit 11 is executed. Herein, it is assumed that a user area is not determined (person detection “x”). In this case, processing by the user switching detection unit 12 is not executed. The image processing apparatus 10 causes the person ID to remain as “1”, causes the resident frame number to remain as “2”, and updates the continuous failure number to “2”. Then, the image processing apparatus 10 causes the image to be referred to and the image to be compared to remain as the image of the frame number 2.

Next, an image of a frame number 5 is designated as an image to be processed, and processing by the user area determination unit 11 is executed. Herein, it is assumed that a user area is determined (person detection “o”). Then, the user switching detection unit 12 executes same person decision processing described in the processing for the image of the frame number 2. Herein, it is assumed that decision as being the same person is made (same decision “o”). The image processing apparatus 10 causes the person ID to remain as “1”, and updates the resident frame number to “5”. In other words, it is assumed that, also in a period of the frames 3 and 4 in which person detection fails, residence is done. Then, the image processing apparatus 10 updates the continuous failure number to “0”. Further, the image processing apparatus 10 updates the image to be processed and the image to be referred to the image of the frame number 5.

Next, an image of a frame number 6 is designated as an image to be processed, and processing by the user area determination unit 11 is executed. Herein, it is assumed that a user area is determined (person detection “o”). Then, the user switching detection unit 12 executes same person decision processing described in the processing for the image of the frame number 2. Herein, it is assumed that decision as not being the same person is made (same decision “x”). The image processing apparatus 10 causes the person ID to remain as “1”, causes the resident frame number to remain as “5”, and updates the continuous failure number to “1”. Further, the image processing apparatus 10 causes the image to be referred to and the image to be compared to remain as the image of the frame number 5.

Next, an image of a frame number 7 is designated as an image to be processed, and processing by the user area determination unit 11 is executed. Herein, it is assumed that a user area is determined (person detection “o”). Then, the user switching detection unit 12 executes same person decision processing described in the processing for the image of the frame number 2. Herein, it is assumed that decision as not being the same person is made (same decision “x”). The image processing apparatus 10 causes the person ID to remain as “1”, causes the resident frame number to remain as “5”, and updates the continuous failure number to “2”. Further, the image processing apparatus 10 causes the image to be referred to and the image to be compared to remain as the image of the frame number 5.

Next, an image of a frame number 8 is designated as an image to be processed, and processing by the user area determination unit 11 is executed. Herein, it is assumed that a user area is not determined (person detection “x”). In this case, processing by the user switching detection unit 12 is not executed. The image processing apparatus 10 causes the person ID to remain as “1”, causes the resident frame number to remain as “5”, and updates the continuous failure number to “3”. Then, the image processing apparatus 10 causes the image to be referred to and the image to be compared to remain as the image of the frame number 5.

Hereinafter, while similar processing is executed, in each of images of frame numbers 9 to 20, it is assumed that a user area is determined (person detection “o”) but decision as not being the same person is made (same decision “x”). At a time when processing in which the frame number 20 is a processing target is finished, the person ID is “1”, the resident frame number is “5”, the continuous failure number is “15”, and the image to be referred to and the image to be compared is the image of the frame number 5.

Next, an image of a frame number 21 is designated as an image to be processed, and processing by the user area determination unit 11 is executed. Herein, it is assumed that a user area is determined (person detection “o”). Then, the user switching detection unit 12 executes same person decision processing described in the processing for the image of the frame number 2. Herein, it is assumed that decision as not being the same person is made (same decision “x”). As a result, the continuous failure number becomes “16 (equal to or more than M)”. Therefore, the image processing apparatus 10 updates the person ID to “2”. Further, a timing of switching of a user is determined as a time of a first failure of the 16 continuous failures (a timing of generating the frame number 6), and therefore the image processing apparatus 10 updates the resident frame number to “16”. Further, the image processing apparatus 10 updates the continuous failure number to “0”. Furthermore, the image processing apparatus 10 updates the image to be referred to and the image to be compared to the image of the frame number 21.

Hereinafter, similar processing is repeated. Note that, in the above-described example, the image to be referred to and the image to be compared each are a latest image among images in which decision as being the same person is made based on same person decision processing by the user switching detection unit 12.

Referring back to FIG. 4, the output unit 13 outputs information relating to a detection result by the user switching detection unit 12. By using a dedicated system, a mail, an application, or the like, the output can be achieved.

The output unit 13 may compute, for example, based on a detection result by the user switching detection unit 12, a usage time of each user in real time, and output a computation result. An output destination is a display or the like browsed by a surveillance member.

As another example, the output unit 13 may compute, based on a detection result by the user switching detection unit 12, a usage time of each user in real time, and also survey whether the usage time exceeds a reference value. Then, when the usage time exceeds the reference value, warning information may be output. An output destination is, for example, a display, a speaker, or the like installed in the operation terminal or near the operation terminal. It is conceivable that warning information in this case is a message for arousing attention such as “Please be careful of billing fraud”. In addition, the output destination may be a display or a speaker viewed by a surveillance member, an administrator of the operation terminal, or the like, and in addition, mobile terminals or the like carried by these persons. It is conceivable that warning information in this case is a massage for arousing attention such as “A usage time of a customer of an operation terminal 3 exceeds a reference value. There is a possibility of billing fraud. Please make confirmation.”.

As another example, the output unit 13 may directly output a processing result by the user switching detection unit 12. A processing result to be output includes a decision result of whether a user is switched, and a timing of switching of a user of an operation terminal in a case of making decision as being switched (in case of the example in FIG. 7, a date and time in which the image of the frame number 6 is generated). Note that, the output unit 13 may output, only when it is decided that a user is switched, information indicating this matter and a timing of switching of a user of an operation terminal. An output destination is an apparatus that executes predetermined processing. The apparatus surveys, for example, based on input information, a usage time of each user, and executes warning processing according to the usage time.

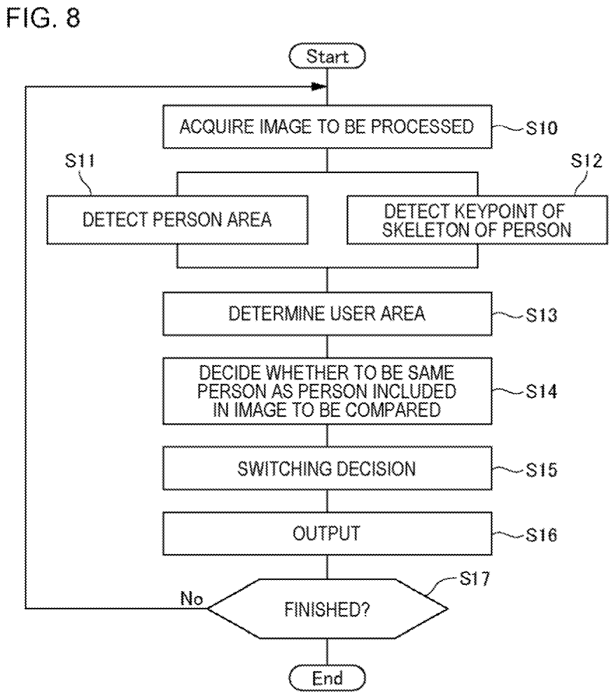

Next, by using a flowchart in FIG. 8, one example of a flow of processing of the image processing apparatus 10 is described. Note that, details of each piece of processing have been described above, and therefore description herein is omitted, as appropriate. As real time processing, the following processing for an image generated by a surveillance camera is executed.

First, the image processing apparatus 10 acquires one image as an image to be processed (S10). Then, the image processing apparatus 10 executes processing of detecting a person area for the image to be processed (S11), and processing of detecting a keypoint of a skeleton of a person (S12).

Then, the image processing apparatus 10 determines, based on a first detection result in which the person area is detected and a second detection result in which the keypoint of the skeleton of the person is detected, a user area from the image to be processed (S13).

Then, the image processing apparatus 10 decides, based on a comparison result between feature data extracted from an image of the user area in the image to be processed and feature data extracted from an image of a user area in an image to be compared, whether persons included in these user areas are the same person (S14). Note that, when there is no image generated before the image to be processed, the processing may be skipped.

Then, the image processing apparatus 10 decides, based on the decision result in S14 and a history of decision results so far, whether a user of the operation terminal is switched (S15). Note that, when there is no image generated before the image to be processed, the processing may be skipped.

Then, the image processing apparatus 10 outputs the decision result in S15 (S16),

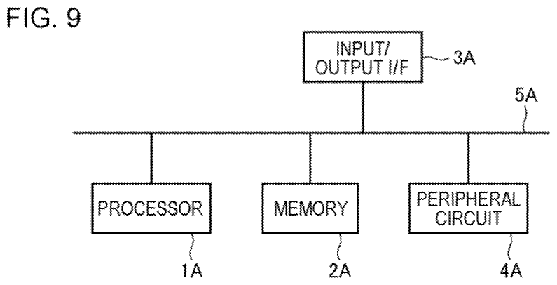

“Hardware Configuration of Image Processing Apparatus” One example of a hardware configuration of the image processing apparatus 10 is described. FIG. 9 is a diagram illustrating a hardware configuration example of the image processing apparatus 10. Each function unit included in the image processing apparatus 10 is achieved by any combination of hardware and software mainly including a central processing unit (CPU) of any computer, a memory, a program loaded onto a memory, a storage unit (capable of storing, in addition to a program previously stored from a shipment stage of an apparatus, a program downloaded from a storage medium such as a compact disc (CD) or a server or the like on the Internet) such as a hard disk storing the program, and a network connection interface. Then, those of ordinary skill in the art should understand that there are various modified examples for the achievement method and the apparatus.

As illustrated in FIG. 9, the image processing apparatus 10 includes a processor 1A, a memory 2A, an input/output interface 3A, a peripheral circuit 4A, and a bus 5A. The peripheral circuit 4A includes various modules. The image processing apparatus 10 does not necessarily include the peripheral circuit 4A. Note that, the image processing apparatus 10 may be configured by using a plurality of apparatuses separated physically and/or logically, or may be configured by using one apparatus integrated physically and logically. In the former case, each of a plurality of apparatuses configuring the image processing apparatus 10 can include the above-described hardware configuration.

The bus 5A is a data transmission path in which the processor 1A, the memory 2A, the peripheral circuit 4A, and the input/output interface 3A mutually transmit/receive data. The processor 1A is an arithmetic processing apparatus, for example, such as a CPU and a graphics processing unit (GPU). The memory 2A is a memory, for example, such as a random access memory (RAM) and a read only memory (ROM). The input/output interface 3A includes an interface for acquiring information from an input apparatus, an external apparatus, an external server, an external sensor, and the like, an interface for outputting information to an output apparatus, an external apparatus, an external server, and the like, and the like. The input apparatus is, for example, a keyboard, a mouse, a microphone, or the like. The output apparatus is, for example, a display, a speaker, a printer, a mailer, or the like. The processor 1A can issue an instruction to each module, and thereby, perform an arithmetic operation, based on arithmetic operation results of the modules.

### “Advantageous Effects of Image Processing Apparatus”

As described above, the image processing apparatus 10 executes “processing of detecting that a user of an operation terminal is switched”.

When a surveillance camera exhibits high performance (e.g., a high frame rate, high resolution, or the like) or is installed in an appropriate location and direction, a plurality of users detected in an image can be discriminated. with high accuracy. from each other, by using a well-known tracking technique or a face recognition technique. Therefore, it is unnecessary to purposely execute processing of detecting that a user of an operation terminal is switched. Actually, in the technique described in Patent Documents 1 and 2 in which it is conceivable that it is assumed that a surveillance camera exhibits high performance and is installed in an appropriate location and direction, “processing of detecting that a user of an operation terminal is switched” is not executed.

However, as seen according to the present example embodiment, when a surveillance camera exhibits low performance (e.g., a low frame rate, low resolution, or the like) or an installation location is not appropriate, it is difficult to discriminate, with high accuracy, a plurality of users detected in an image from each other, by using a well-known tracking technique or a face recognition technique. As a result, there is a risk that users different from each other is determined as the same person, or that the same person captured over a plurality of images is determined as users different from each other. As a result, accuracy of a computation result of a usage time of an operation terminal of each user is worsened.

Therefore, the image processing apparatus 10 executes “processing of detecting that a user of an operation terminal is switched” which has not been executed in a conventional technique, and computes, based on the detection result, a usage time of the operation terminal of each user. As a result, even when a surveillance camera has limitation to performance and an installation location, a usage time of an operation terminal of each user can be accurately computed.

Moreover, each of pieces of processing executed by the image processing apparatus includes a characteristic content suitable for processing for an image generated by a surveillance camera having limitation to performance and an installation location. Therefore, even when a surveillance camera has limitation to performance and an installation location, accuracy of processing of the image processing apparatus 10 is improved. As a result, a usage time of an operation terminal of each user can be accurately computed.

Moreover, the image processing apparatus 10 does not add, as described by using FIG. 7, a resident frame number when person detection or same decision fails. As seen according to the present example embodiment, when a surveillance camera exhibits low performance (e.g., a low frame rate, low resolution, or the like) or an installation location is not appropriate, a possibility of failure of person detection or same decision is relatively high. Therefore, when a resident frame number is added when person detection or same decision fails, there is a risk that error warning is output. The image processing apparatus 10 can reduce the inconvenience, based on a configuration that “when person detection or same decision fails, a resident frame number is not added”.

### Second Example Embodiment

### “Outline of Image Processing Apparatus”

An image processing apparatus 10 according to the present example embodiment analyzes an image generated by a surveillance camera and detects that a user of an operation terminal is taking a phone call pose. Then, a surveillance camera used according to the present example embodiment has also limitation to performance and an installation location, similarly to the first example embodiment. Therefore, processing of detecting a phone call pose executed by the image processing apparatus 10 according to the present example embodiment includes a characteristic content suitable for processing for an image generated by a surveillance camera having limitation to performance and an installation location. Therefore, even when a surveillance camera has limitation to performance and an installation location, accuracy of the processing is improved.

### “Function Configuration of Image Processing Apparatus”

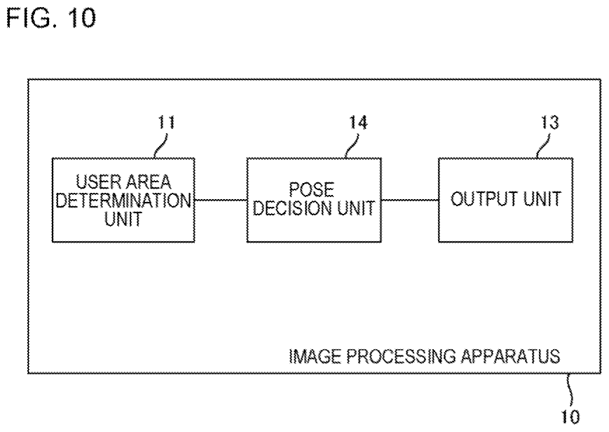

FIG. 10 illustrates one example of a function block diagram of the image processing apparatus 10 according to the present example embodiment. As illustrated, the image processing apparatus 10 is different from the image processing apparatus 10 according to the first example embodiment in that, instead of the user switching detection unit 12, a pose decision unit 14 is included.

A configuration of a user area determination unit 11 is similar to that of the first example embodiment, and therefore description herein is omitted.

The pose decision unit 14 computes, based on an image of a user area, a degree of certainty of taking a predetermined pose by a user of an operation terminal. The predetermined pose is a phone call pose. The pose decision unit 14 detects a phone call pose, based on a keypoint of a skeleton of a person detected from an image of a user area. Specifically, the pose decision unit 14 decides, when a target keypoint being a part of keypoints of a skeleton of a person is being in a predetermined state, i.e., a target keypoint being in a predetermined state is detected in an image of a user area, that a user of the operation terminal is taking a phone call pose.

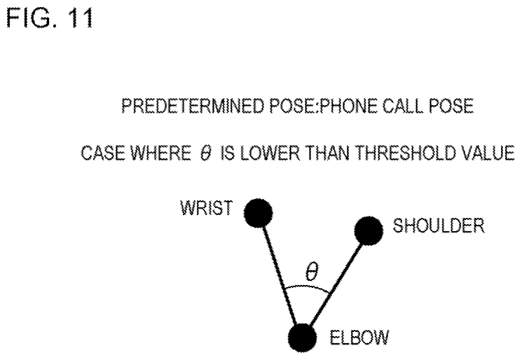

Herein, a target keypoint being in a predetermined state is described. For example, as illustrated in FIG. 11, keypoints relevant to a wrist, an elbow, and a shoulder indicate a target keypoint. Then, a state in which an angle θ formed by a keypoint of a wrist, a keypoint of an elbow, and a keypoint of a shoulder is equal to or more than a threshold value is the predetermined state. Note that, the target keypoint being in the predetermined state exemplified herein is merely one example without limitation.

As described above, a surveillance camera has limitation to performance and an installation location. Detection accuracy of a target keypoint being in a predetermined state detected by processing an image generated by such a surveillance camera is worsened. Therefore, when it is decided that a phone call pose is being taken according to detection of a target keypoint being in a predetermined state, accuracy of the decision is worsened. Therefore, the pose decision unit 14 computes, based on a history of detection results of a target keypoint being in a predetermined state, a degree of certainty of taking a predetermined pose by a user of an operation terminal. Then, it is decided that, when the degree of certainty exceeds a reference value, the user of the operation terminal is taking the predetermined pose. Hereinafter, a computation method of the degree of certainty is described.

The pose decision unit 14 executes processing (processing of detecting a predetermined pose) of detecting, for each of a plurality of time-series images to be processed, a target keypoint being in a predetermined state in time-series order. Then, the pose decision unit 14 determines a degree of certainty according to the number of times in which a predetermined pose is continuously detected. With an increase in the number of continuous detection, a degree of certainty increases.

Herein, one example of processing of determining a degree of certainty according to the number of times in which a predetermined pose is continuously detected is described. In the example, the pose decision unit 14 updates, based on the following rules, a degree of certainty.
(Rule 1) When a target keypoint being in a predetermined state is detected from an image to be processed, a degree of certainty is increased by a predetermined value.
(Rule 2) When a target keypoint not being in a predetermined state is detected from an image to be processed, a degree of certainty is reset to an initial value.
(Rule 3) When a target keypoint is not detected from an image to be processed, a degree of certainty is maintained as is.

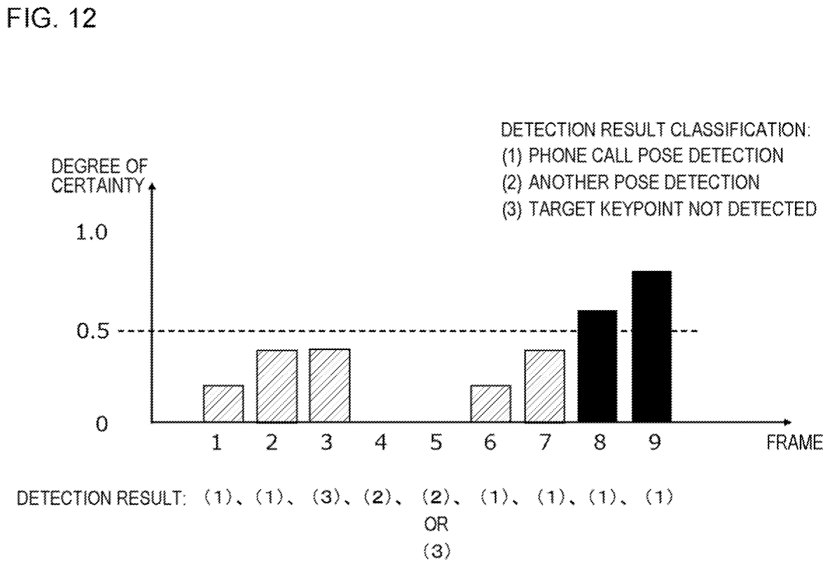

By using FIG. 12, a specific example is described. A horizontal axis indicates a number (frame number) of an image to be processed, and a vertical axis indicates a degree of certainty.

Detection result (1) “Phone call pose detection” is a case where a target keypoint being in a predetermined state is detected from an image to be processed. In this case, the rule 1 is applied.

Detection result (2) “Another pose detection” is a case where a target keypoint not being in a predetermined state is detected from an image to be processed. In this case, the rule 2 is applied.

Detection result (3) “A target keypoint not detected yet” is a case where a target keypoint is not detected from an image to be processed. In this case, the rule 3 is applied.

As illustrated in FIG. 12, a detection result of a frame 1 is (1). Therefore, the rule 1 is applied and a degree of certainty is increased by a predetermined value.

Next, a detection result of a frame 2 is also (1). Therefore, the rule 1 is applied and the degree of certainty is further increased by a predetermined value.

Next, a detection result of a frame 3 is (3). Therefore, the rule 3 is applied and the degree of certainty is maintained as is.

Next, a detection result of a frame 4 is (2). Therefore, the rule 2 is applied and the degree of certainty is reset to an initial value.

Next, a detection result of a frame 5 is (2) or (3). Therefore, the rule 2 is applied and the degree of certainty is reset to the initial value, or the rule 3 is applied and the degree of certainty is maintained still as the initial values.

Next, each of detection results of frames 6 to 9 is (1). Therefore, the rule 1 is applied and the degree of certainty is increased by a predetermined value for each result.

Referring back to FIG. 10, an output unit 13 outputs warning information when a degree of certainty computed by the pose decision unit 14 exceeds a reference value. An output destination is, for example, a display, a speaker, or the like installed in the operation terminal or near the operation terminal. It is conceivable that warning information in this case is a message for arousing attention such as “Please be careful of billing fraud”. In addition, the output destination may be a display or a speaker viewed by a surveillance member, an administrator of the operation terminal, or the like, and in addition, mobile terminals or the like carried by these persons. It is conceivable that warning information in this case is a massage for arousing attention such as “A customer of an operation terminal 3 is performing an operation while calling. There is a possibility of billing fraud. Please make confirmation.”.

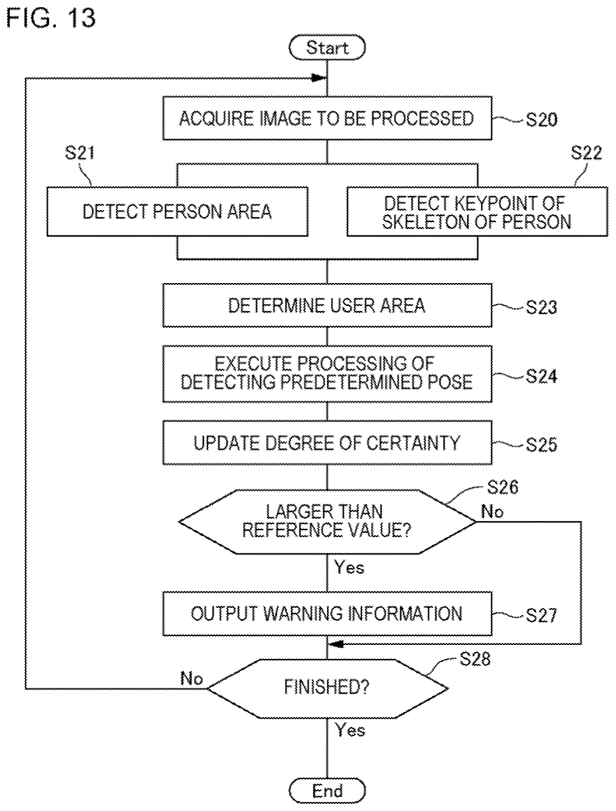

Next, by using a flowchart in FIG. 13, one example of a flow of processing of the image processing apparatus 10 is described. Note that, details of each piece of processing have been described above, and therefore description herein is omitted, as appropriate. As real time processing, the following processing for an image generated by a surveillance camera is executed.

First, the image processing apparatus 10 acquires one image as an image to be processed (S20). Then, the image processing apparatus 10 executes processing of detecting a person area for the image to be processed (S21), and processing of detecting a keypoint of a skeleton of a person (S22).

Then, the image processing apparatus 10 determines, based on a first detection result in which the person area is detected and a second detection result in which the keypoint of the skeleton of the person is detected, a user area from the image to be processed (S23).

Then, the image processing apparatus 10 executes processing (processing of detecting a predetermined pose) of detecting a target keypoint being in a predetermined state from an image of a user area (S24). Then, the image processing apparatus 10 updates, based on a detection result in S24, a degree of certainty in which a user of an operation terminal is taking the predetermined pose (S25).

When the degree of certainty exceeds a reference value (Yes in S26), the image processing apparatus 10 outputs warning information (S27). Note that, when the degree of certainty does not exceed the reference value (No in S26), the image processing apparatus 10 does not output warning information.

### Modified Example

Herein, a modified example of the image processing apparatus 10 according to the present example embodiment is described. The pose decision unit 14 computes, based on a keypoint of a right side of a body among keypoints of a skeleton of a person detected from an image to be processed, a degree of certainty of taking a predetermined pose by the right side of the body of the person. Moreover, the pose decision unit 14 computes, based on a keypoint of a left side of the body among the keypoints of the skeleton of the person detected from the image to be processed, a degree of certainty of taking a predetermined pose by the left side of the body of the person. A computation method of a predetermined pose and a degree of certainty are as described above.

Then, the pose decision unit 14 computes, as a degree of certainty of taking a predetermined pose by a user of an operation terminal, a larger degree of certainty between the degree of certainty of taking a predetermined pose by the right side of the body of the person and the degree of certainty of taking a predetermined pose by the left side of the body of the person.

The output unit 13 outputs warning information when the degree of certainty determined described above (the larger degree of certainty between the degree of certainty of taking the predetermined pose by the right side of the body of the person and the degree of certainty of taking the predetermined pose by the left side of the body of the person) exceeds a reference value.

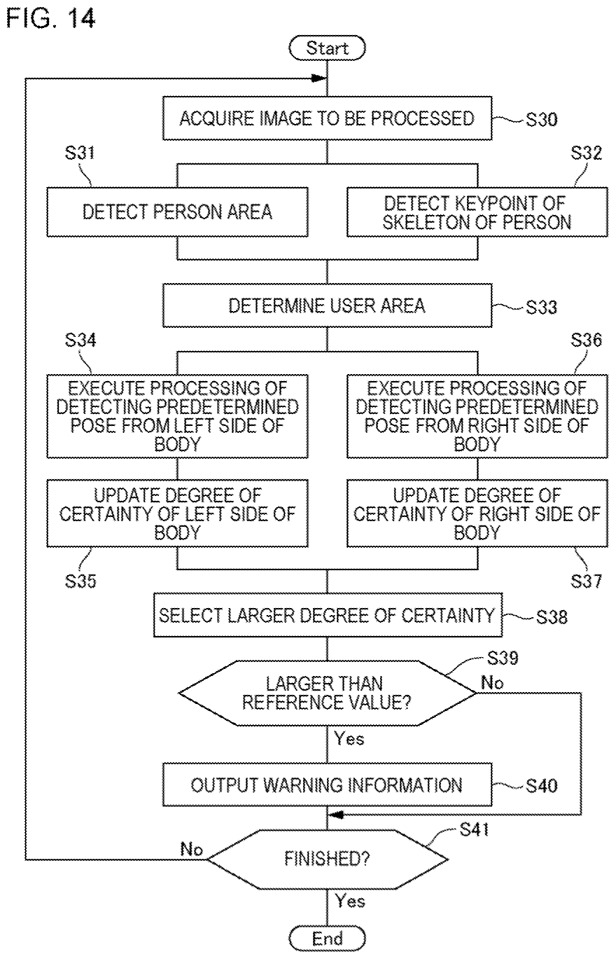

Next, by using a flowchart in FIG. 14, one example of a flow of processing of the image processing apparatus 10 according to the modified example is described. Note that, details of each piece of processing have been described above, and therefore description herein is omitted, as appropriate. As real time processing, the following processing for an image generated by a surveillance camera is executed.

First, the image processing apparatus 10 acquires one image as an image to be processed (S30). Then, the image processing apparatus 10 executes processing of detecting a person area for the image to be processed (S31), and processing of detecting a keypoint of a skeleton of a person (S32).

Then, the image processing apparatus 10 determines, based on a first detection result in which the person area is detected and a second detection result in which the keypoint of the skeleton of the person is detected, a user area from the image to be processed (S33).

Then, the image processing apparatus 10 executes, based on a keypoint of a left side of a body among keypoints of the skeleton of the person detected from an image of the user area, processing (processing of detecting a predetermined pose) of detecting a target keypoint being in a predetermined state (S34). Then, the image processing apparatus 10 updates, based on a detection result in S34, a degree of certainty of taking the predetermined pose by the left side of the body of a user of an operation terminal (S35).

Moreover, the image processing apparatus 10 executes, based on a keypoint of a right side of the body among the keypoints of the skeleton of the person detected from the image of the user area, processing (processing of detecting a predetermined pose) of detecting a target keypoint being in a predetermined state (S36). Then, the image processing apparatus 10 updates, based on a detection result in S36, a degree of certainty of taking the predetermined pose by the right side of the body of the user of the operation terminal (S37).

Then, the image processing apparatus 10 selects a larger degree of certainty between the degree of certainty of taking the predetermined pose by the left side of the body of the user of the operation terminal and the degree of certainty of taking the predetermined pose by the right side of the body of the user of the operation terminal (S38).

Then, when the selected degree of certainty exceeds a reference value (Yes in S39), the image processing apparatus 10 outputs warning information (S40). Note that, when the selected degree of certainty does not exceed the reference value (No in S39), the image processing apparatus 10 does not output warning information.

### “Hardware Configuration of Image Processing Apparatus”

A hardware configuration of the image processing apparatus 10 is similar to that of the first example embodiment.

### “Advantageous Effects of Image Processing Apparatus”

The image processing apparatus 10 according to the present example embodiment analyzes an image generated by a surveillance camera and detects that a user of an operation terminal is taking a phone call pose. Then, processing of detecting a phone call pose executed by the image processing apparatus 10 according to the present example embodiment includes a characteristic content suitable for processing for an image generated by a surveillance camera having limitation to performance and an installation location. Therefore, even when a surveillance camera has limitation to performance and an installation location, accuracy of the processing is improved.

### Third Example Embodiment

An image processing apparatus 10 according to the present example embodiment includes the function described according to the first example embodiment and the function described according to the second example embodiment.

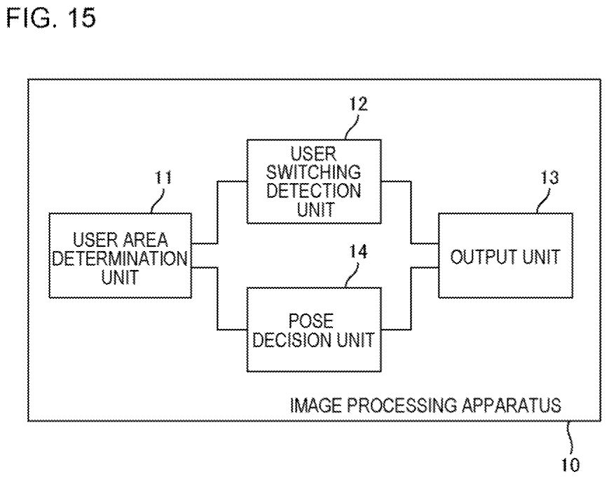

FIG. 15 illustrates one example of a function block diagram of the image processing apparatus 10. As illustrated, the image processing apparatus 10 includes a user area determination unit 11, a user switching detection unit 12, an output unit 13, and a pose decision unit 14.

A function configuration of each of the user area determination unit 11, the user switching detection unit 12, and the pose decision unit 14 is as described according to the first and the second example embodiments.

The output unit 13 may include both of the output processing described according to the first example embodiment and the output processing described according to the second example embodiment. In other words, pieces of output processing according to a detection result by the user switching detection unit 12 and a determination result by the pose decision unit 14 may be executed separately.

In addition, the output unit 13 may execute output processing based on integration of a detection result by the user switching detection unit 12 and a decision result by the pose decision unit 14. The output unit 13 may output warning information, for example, when a usage time of a user of an operation terminal computed based on a detection result by the user switching detection unit 12 exceeds a predetermined reference value and also a degree of certainty computed by the pose decision unit 14 exceeds a reference value.

An output destination is, for example, a display or a speaker installed in the operation terminal or near the operation terminal. It is conceivable that warning information in this case is a message for arousing attention such as “Please be careful of billing fraud”. In addition, the output destination may include a display or a speaker viewed by a surveillance member, an administrator of the operation terminal, or the like, and in addition, mobile terminals or the like carried by these persons. It is conceivable that warning information in this case is a massage for arousing attention such as “A usage time of a customer of an operation terminal 3 exceeds a reference value. And in addition, the customer is performing an operation while calling. There is a possibility of billing fraud. Please make confirmation.”.

A hardware configuration of the image processing apparatus 10 is similar to that of the first example embodiment.

According to the image processing apparatus 10 of the present example embodiment, advantageous effects similar to those of the first and the second example embodiments are achieved.

As described above, while with reference to the accompanying drawings, example embodiments of the present invention have been described, the example embodiments are exemplification of the present invention, and various configurations other than the above-described configurations are employable.

Note that, in the present description, “acquisition” includes at least any one of a matter that “a local apparatus fetches data stored in another apparatus or a storage medium (active acquisition)”, based on user input or based on an instruction from a program, e.g., a matter that reception is executed by making a request or an inquiry to another apparatus, a matter that reading is executed by accessing another apparatus or a storage medium, or the like; a matter that “data output from another apparatus are input to a local apparatus (passive acquisition)”, based on user input or based on an instruction from a program, e.g., a matter that data distributed (or transmitted, notified on a push basis, or the like) are received, a matter that selective acquisition is executed from among received pieces of data or information, or the like; and a matter that “new data are generated by data editing (conversion to text, data rearrangement, partial data extraction, file-format modification, and like), and the new data are acquired”.

The whole or part of the example embodiments disclosed above can be described as, but not limited to, the following supplementary notes.
1. An image processing apparatus including:
a user area determination unit that determines, from an image to be processed, a user area being an area where a user of an operation terminal is present; and
a user switching detection unit that detects, based on an image of the user area, that the user of the operation terminal is switched.
2. The image processing apparatus according to supplementary note 1, wherein the user switching detection unit detects that the user of the operation terminal is switched, based on a comparison result between feature data extracted from the image of the user area in the image to be processed and feature data extracted from the image of the user area in an image to be compared generated before the image to be processed.
3. The image processing apparatus according to supplementary note 2, wherein
the user switching detection unit
   repeatedly executes, by using a plurality of images in order as the image to be processed, processing of deciding, based on a comparison result between the feature data extracted from the image to be processed and the feature date extracted from the image to be compared, whether a person included in the image of the user area in the image to be processed and a person included in the image of the user area in the image to be compared are the same person,
   decides, when decision as not being the same person is made in continuous M (M is an integer equal to or more than 2) or more images to be processed, that the user of the operation terminal is switched, and
   decides, as a timing of switching of the user of the operation terminal, a timing at which the image to be processed in which a time-series order in the continuous M images to be processed is earliest is generated.
4. The image processing apparatus according to any one of supplementary notes 1 to 3, wherein
the user area determination unit
   determines, based on a first detection result in which a person area is detected from the image to be processed and a second detection result in which a keypoint of a skeleton of a person is detected from the image to be processed, the user area from the image to be processed.
5. The image processing apparatus according to supplementary note 4, wherein
the user area determination unit
   determines, based on a size of the person area with respect to a plurality of the person areas indicated by the first detection result and the keypoint of the skeleton of the person, the person area where the user of the operation terminal is present.
6. The image processing apparatus according to supplementary note 4 or 5, wherein
the user area determination unit
   determines, when the keypoint of the skeleton of the person is not detected from the image to be processed, the user area from the image to be processed, based on the keypoint of the skeleton of the person detected from an image to be referred to generated before the image to be processed.
7. The image processing apparatus according to any one of supplementary notes 1 to 6, further including
an output unit that outputs warning information when a usage time of the user of the operation terminal computed based on a detection result by the user switching detection unit exceeds a reference value.
8. The image processing apparatus according to any one of supplementary notes 1 to 6, further including
a pose decision unit that computes, based on the image of the user area, a degree of certainty of taking a predetermined pose by the user of the operation terminal.

9. The image processing apparatus according to supplementary note 8, further including
an output unit that outputs warning information when a usage time of the user of the operation terminal computed based on a detection result by the user switching detection unit exceeds a reference value and also the degree of certainty computed by the pose decision unit exceeds a reference value.
10. The image processing apparatus according to supplementary note 8 or 9, wherein
a plurality of images are the image to be processed in time-series order, and
the pose decision unit
   executes, for each of a plurality of the images to be processed, processing of detecting the predetermined pose from the image to be processed, and
   determines the degree of certainty according to the number of continuous detections of the predetermined pose.
11. The image processing apparatus according to supplementary note 10, wherein
the pose decision unit
   executes processing of detecting the predetermined pose, based on a target keypoint among keypoints of a skeleton of a person detected from the image to be processed,
   detects, as processing of detecting the predetermined pose, the target keypoint being in a predetermined state,
   increases the degree of certainty when the target keypoint being in the predetermined state is detected from the image to be processed,
   resets the degree of certainty to an initial value when the target keypoint not being in the predetermined state is detected from the image to be processed, and
   maintains the degree of certainty as is when the target keypoint is not detected from the image to be processed.
12. The image processing apparatus according to any one of supplementary notes 8 to 11, wherein
the pose decision unit
   computes, based on a keypoint of a right side of a body among keypoints of a skeleton of a person detected from the image to be processed, a degree of certainty of taking the predetermined pose by the right side of the body of the person,
   computes, based on a keypoint of a left side of a body among keypoints of a skeleton of a person detected from the image to be processed, a degree of certainty of taking the predetermined pose by the left side of the body of the person, and
computes, as a degree of certainty of taking the predetermined pose by the user of the operation terminal, a larger degree of certainty between a degree of certainty of taking the predetermined pose by the right side of the body of the person and a degree of certainty of taking the predetermined pose by the left side of the body of the person.
13. An image processing method including,
by a computer:
   determining, from an image to be processed, a user area being an area where a user of an operation terminal is present; and
   detecting, based on an image of the user area, that the user of the operation terminal is switched.
14. A program causing a computer to function as:
   a user area determination unit that determines, from an image to be processed, a user area being an area where a user of an operation terminal is present; and
   a user switching detection unit that detects, based on an image of the user area, that the user of the operation terminal is switched.

This application is based upon and claims the benefit of priority from Japanese patent application No. 2021-006332, filed on Jan. 19, 2021, the disclosure of which is incorporated herein in its entirety by reference.

### REFERENCE SIGNS LIST

10 Image processing apparatus
11 User area determination unit
12 User switching detection unit
13 Output unit
14 Pose decision unit
1A Processor
2A Memory
3A Input/output I/F
4A Peripheral circuit
5A Bus

What is claimed is:

1. An image processing apparatus comprising:
at least one memory configured to store one or more instructions; and
at least one processor configured to execute the one or more instructions to:
determine, from an image to be processed, a user area being an area where a user of an operation terminal is present; and
detect, based on an image of the user area, that the user of the operation terminal is switched.

2. The image processing apparatus according to claim 1, wherein
the processor is further configured to execute the one or more instructions to detect that the user of the operation terminal is switched, based on a comparison result between feature data extracted from the image of the user area in the image to be processed and feature data extracted from the image of the user area in an image to be compared generated before the image to be processed.

3. The image processing apparatus according to claim 2, wherein
the processor is further configured to execute the one or more instructions to
repeatedly execute, by using a plurality of images in order as the image to be processed, processing of deciding, based on a comparison result between the feature data extracted from the image to be processed and the feature date extracted from the image to be compared, whether a person included in the image of the user area in the image to be processed and a person included in the image of the user area in the image to be compared are a same person,
decide, when decision as not being the same person is made in continuous M (M is an integer equal to or more than 2) or more images to be processed, that the user of the operation terminal is switched, and
decide, as a timing of switching of the user of the operation terminal, a timing at which the image to be processed in which a time-series order in the continuous M images to be processed is earliest is generated.

4. The image processing apparatus according to claim 1, wherein
the processor is further configured to execute the one or more instructions to
determine, based on a first detection result in which a person area is detected from the image to be processed and a second detection result in which a keypoint of a skeleton of a person is detected from the image to be processed, the user area from the image to be processed.

5. The image processing apparatus according to claim 4, wherein
the processor is further configured to execute the one or more instructions to
determine, when the keypoint of the skeleton of the person is not detected from the image to be processed, the user area from the image to be processed, based on the keypoint of the skeleton of the person detected from an image to be referred to generated before the image to be processed.

6. The image processing apparatus according to claim 1, wherein the processor is further configured to execute the one or more instructions to
compute, based on the image of the user area, a degree of certainty of taking a predetermined pose by the user of the operation terminal.

7. The image processing apparatus according to claim 6, wherein
a plurality of images are the image to be processed in time-series order, and
the processor is further configured to execute the one or more instructions to
execute, for each of a plurality of the images to be processed, processing of detecting the predetermined pose from the image to be processed, and
determine the degree of certainty according to a number of continuous detections of the predetermined pose.

8. The image processing apparatus according to claim 7, wherein
the processor is further configured to execute the one or more instructions to
execute processing of detecting the predetermined pose, based on a target keypoint among keypoints of a skeleton of a person detected from the image to be processed,
detect, as processing of detecting the predetermined pose, the target keypoint being in a predetermined state,
increase the degree of certainty when the target keypoint being in the predetermined state is detected from the image to be processed,
reset the degree of certainty to an initial value when the target keypoint not being in the predetermined state is detected from the image to be processed, and
maintain the degree of certainty as is when the target keypoint is not detected from the image to be processed.

9. An image processing method comprising,
by a computer:
determining, from an image to be processed, a user area being an area where a user of an operation terminal is present; and
detecting, based on an image of the user area, that the user of the operation terminal is switched.

10. A non-transitory storage medium storing a program causing a computer to:
determine, from an image to be processed, a user area being an area where a user of an operation terminal is present; and
detect, based on an image of the user area, that the user of the operation terminal is switched.
